(19) United States
(12) Patent Application Publication
(10) Pub. No.: US 2024/0375264 A1
(43) Pub. Date: Nov. 14, 2024

(54) TOOL STORAGE DEVICE

(71) Applicant: CHUN NIEN PLASTIC LTD., Taichung City (TW)

(72) Inventor: CHI-TSAI CHANG, Taichung City (TW)

(21) Appl. No.: 18/660,786

(22) Filed: May 10, 2024

(30) Foreign Application Priority Data
May 12, 2023 (TW) 112204669

(51) Int. Cl. B25H 3/04

(52) U.S. Cl. CPC B25H 3/04

(57) ABSTRACT

A tool storage device is provided, including: a rail base; a tool clamping seat, including a base, a clamping unit and a resilient member, the clamping unit disposed on the base, the clamping unit including a first clamping portion, a second clamping portion and a clamping space, the first clamping portion and the second clamping portion disposed on the base and spaced apart from each other; the resilient member resiliently abutted against between the connecting portion and the clamping portion.

### BACKGROUND OF THE INVENTION

### Field of the Invention

The present invention relates to a tool storage device.

### Description of the Prior Art

Multiple sizes of hand tools are usually required to match different sizes of driven tools. However, If the multiple sizes of hand tools are stored scattered in a toolbox, they are not easy to be found during use, and the hand tools are also easy to collide to each other and wear. Therefore, storage devices, including material racks, shelving units, etc., are developed by trader, as shown in Taiwan patent number I606903.

A conventional tool storage device typically has two sheet-shaped plates for holding a hand tool, such as screwdriver. However, the conventional tool storage device is easy to insufficient clamping force and fatigue in elasticity, leading to easy to rock or detachment of screwdrivers from the tool storage device.

The present invention is, therefore, arisen to obviate or at least mitigate the above-mentioned disadvantages.

### SUMMARY OF THE INVENTION

The main object of the present invention is to provide a tool storage device, which provides a high clamping force to hold a tool between a first clamping portion and a second clamping portion.

To achieve the above and other objects, the present invention provides a tool storage device, including: a rail base, having two rail grooves; a tool clamping seat, slidably disposed on the rail base, including a base, a clamping unit and a resilient member, two opposite sides of the base having two wing portions, the two wing portions slidably engaged with the two rail grooves, the clamping unit disposed on the base, the clamping unit including a first clamping portion, a second clamping portion and a clamping space, the first clamping portion and the second clamping portion disposed on the base and spaced apart from each other, the first clamping portion including a connecting portion and a clamping portion, the connecting portion connected with the base, the clamping portion connected with the connecting portion and moved relatively to the second clamping portion, the clamping portion and the second clamping portion formed the clamping space therebetween, and the resilient member resiliently abutted against between the connecting portion and the clamping portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is another stereogram of a preferable embodiment of the present invention;

FIG. 3 is a breakdown drawing of a preferable embodiment of the present invention;

FIG. 4 is a cross-sectional view of a preferable embodiment of the present invention;

FIG. 5 is a stereogram of a preferable embodiment of the present invention in use; and

FIG. 6 is a side view drawing of a preferable embodiment of the present invention in use.

### DETAILED DESCRIPTION OF THE PREFERRED EMBODIMENTS

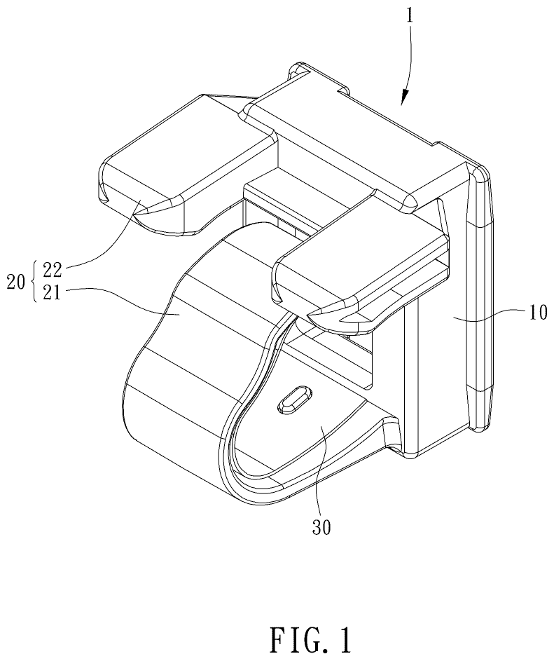

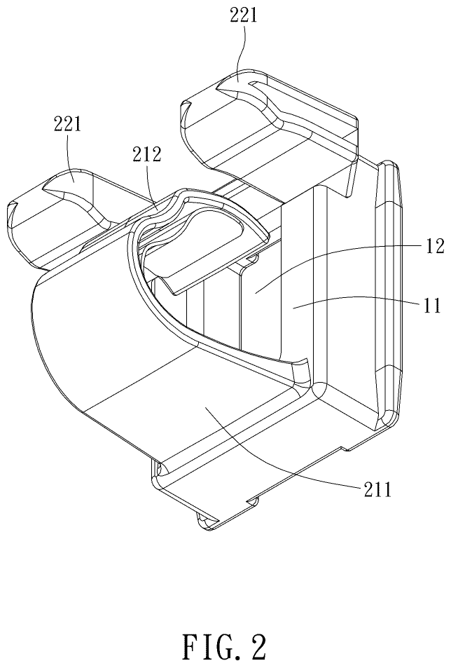

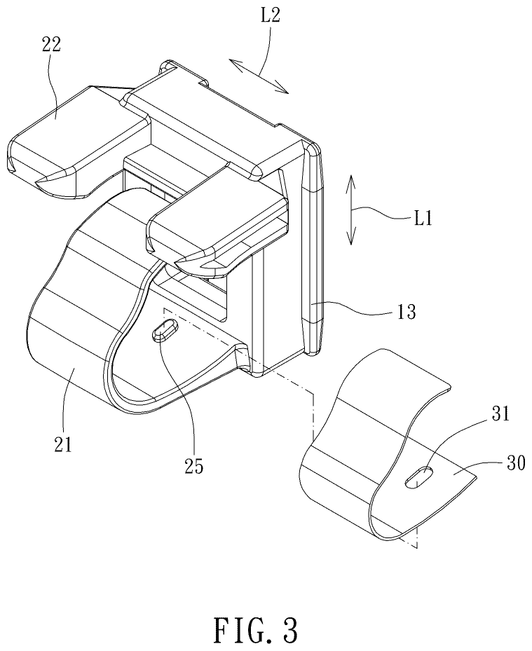

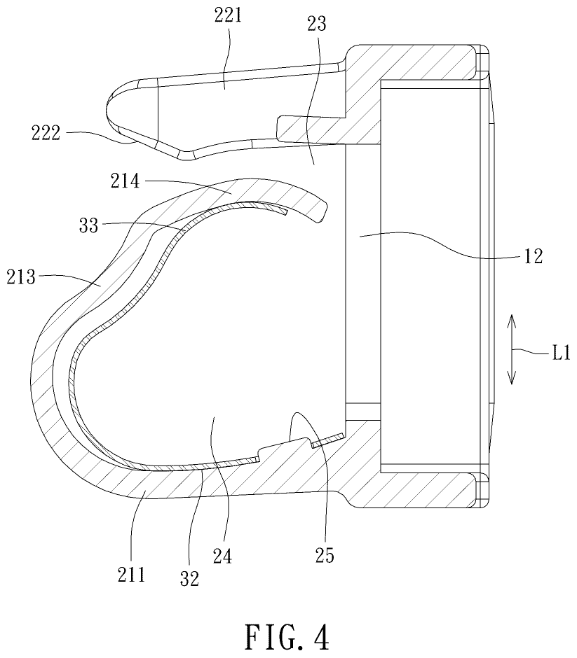

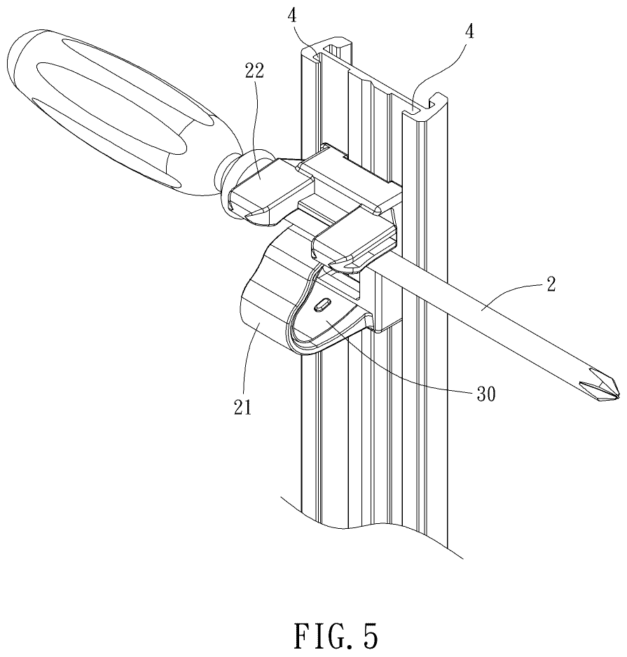

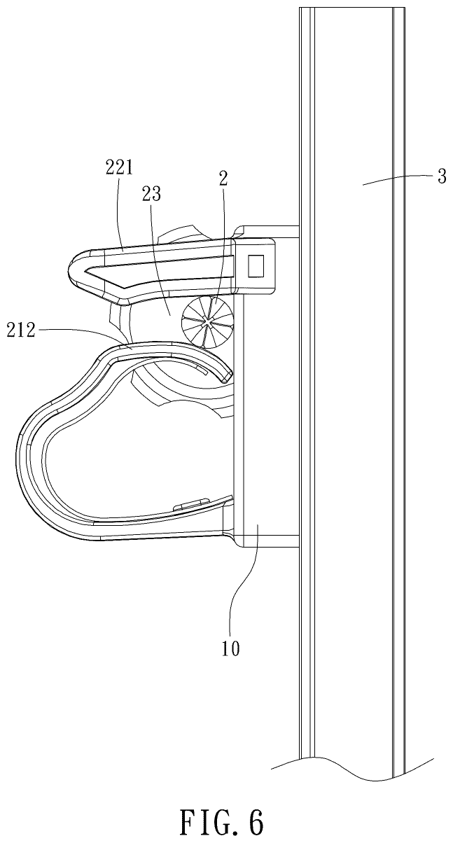

Please refer to FIGS. 1 to 6 for a preferable embodiment of the present invention. A tool storage device of the present invention includes a rail base 3 and a tool clamping seat 1. The tool clamping seat 1 includes a base 10, a clamping unit 20 and a resilient member 30.

The rail base 3 have two rail grooves 4. The tool clamping seat 1 is slidably disposed on the rail base 3. Two opposite sides of the base 10 have two wing portions 13, and the two wing portions 13 are slidably engaged with the two rail grooves 4. The clamping unit 20 is disposed on the base 10. The clamping unit 20 includes a first clamping portion 21, a second clamping portion 22 and a clamping space 23. The first clamping portion 21 and the second clamping portion 22 are disposed on the base the base 10 and spaced apart from each other. The first clamping portion 21 includes a connecting portion 211 and a clamping portion 212, the connecting portion 211 is connected with the base 10, and the clamping portion 212 is connected with the connecting portion 211 and moved (resiliently) relatively to the second clamping portion 22. Specifically, the clamping portion 212 can be moved closer to or away from the second clamping portion 22. The clamping portion 212 and the second clamping portion 22 form the clamping space 23 therebetween. The resilient member 30 is resiliently abutted against between the connecting portion 211 and the clamping portion 212. A tool 2 can be positioned within the clamping space 23 and clamped between the clamping portion 212 and the second clamping portion 22. The tool 2 can be a screwdriver, a shaft body, or another rod-shaped tool.

Therefore, the present invention provides a high clamping force because the clamping portion 212 is resiliently abutted by the resilient member 30, so that the tool 2 can be securely clamped and positioned. Furthermore, a plurality of said tool clamping seats 1 can be slid and accommodated on the rail base 3.

The base 10 and the clamping unit 20 are integrally connected with each other, resulting in a strong connection between them, and the clamping unit 20 can be elastically swung and restored relative to the base 10.

Preferably, the resilient member 30 is a metal flat leaf spring with excellent durability and high rebound force, thus providing strong resilient pushing force to the clamping portion 212. In other embodiment, the resilient member can also be made of elastic plastic material.

The connecting portion 211 and the clamping portion 212 are integrally connected with each other to form a U-shape. In this embodiment, the tool clamping seat 1 further includes a compression space 24 formed between the connecting portion 211 and the clamping portion 212, and the clamping portion 212 is movable (swayable) relative to the compression space 24; thereby, when the clamping portion 212 is pressed towards the connecting portion 211 by an external pressure such as the tool 2, the resilient member 30 provides a rebound force to move the clamping portion 212 to resiliently abut against the tool 2 disposed within the clamping space 23 to stably clamp the tool 2.

The resilient member 30 is disposed within the compression space 24. One of an inner wall of the first clamping portion 21 and the resilient member 30 has a locking protrusion 25, the other of an inner wall of the first clamping portion 21 and the resilient member 30 has a locking hole 31. The locking protrusion 25 is engaged within the locking hole 31. In this embodiment, the inner wall of the connecting portion 211 has the locking protrusion 25. The resilient member 30 includes a connecting end portion 32 and a free end portion 33. The connecting end portion 32 and the free end portion 33 are integrally connected with each other. The connecting end portion 32 has the locking hole 31, and the free end portion 33 resiliently abuts against the clamping portion 212, allowing the resilient member 30 to be stably connected with the first clamping portion 21 and not easily be detached; besides, the resilient member 30 can be quick disassembled and replaced. For example, the resilient member 30 can be replaced when its elasticity deteriorates after long-term use, or it can be replaced with varying elasticity strength based on an outer diameter size of the tool 2.

The resilient member 30 is substantially u-shaped, and a shape of the resilient member 30 corresponds to a shape formed by the connecting portion 211 and the clamping portion 212. Accordingly, the resilient member 30 has a large contact area with both the connecting portion 211 and the clamping portion 212, allowing it to stably support between the connecting portion 211 and the clamping portion 212. Therefore, when the resilient member 30 is compressed by an external forces, it is not easily shaken and can stably push the clamping portion 212. Specifically, when the tool 2 is inserted into the clamping space 23, the tool 2 laterally compresses the clamping portion 212 towards the connecting portion 211 and compresses the resilient member 30, so that the resilient member 30 provides high rebound force to clamp the tool 2 firmly.

The clamping portion 212 is substantially wavy-shaped, the clamping portion 212 includes a first curved segment 213 and a second curved segment 214, the first curved segment 213 is connected between the second curved segment 214 and the connecting portion 211, the second curved segment 214 is a free end and bends towards the connecting portion 211, and the first curved segment 213 and the second curved segment 214 bend in opposite directions. When the tool 2 is clamped between the first clamping portion 21 and the second clamping portion 22, the second curved segment 214 can easily resiliently press against the second clamping portion 22, thereby increasing the clamping force.

The base 10 defines a first direction L1 and a second direction L2, the first direction L1 is transverse to the second direction L2, the first clamping portion 21 and the second clamping portion 22 are arranged in the first direction L1, the second clamping portion 22 includes a plurality of clamping arms 221 which are spaced apart from each other in the second direction L2. Therefore, material can be saved and the overall weight can be reduced; besides, the tool 2 can be firmly clamped.

Each of the plurality of the clamping arms 221 obliquely extends towards the first clamping portion 21, allowing each of the plurality of the clamping arms 221 normally to push the tool 2 towards the first clamping portion 21, resulting in a strong clamping force. Furthermore, it is difficult for the tool 2 to detach from the clamping space 23.

A top portion of each of the plurality of the clamping arms 221 has an inclined surface 222 that faces the first clamping portion 21. Specifically, the tool 2 can move the second clamping portion 22 and the clamping portion 212 outward, and smoothly slide into the clamping space 23 by pressing against the inclined surface 22.

The base 10 has a top surface 11, the clamping unit 20 is disposed on the top surface 11, and the top surface 11 has a recess 12 which corresponds to the clamping portion 212. The recess 12 can be a blind hole or a through hole, not only to reduce the overall weight but also to prevent interference between the clamping portion 212 and the base 10 when the clamping portion 212 is moved relative to the connecting portion 211 and the second clamping portion 22. Therefore, a size of the clamping portion 212 can be designed larger to increase clamping force and clamping area.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool storage device, including:
a rail base, having two rail grooves;
a tool clamping seat, slidably disposed on the rail base, including a base, a clamping unit and a resilient member, two opposite sides of the base having two wing portions, the two wing portions slidably engaged with the two rail grooves, the clamping unit disposed on the base, the clamping unit including a first clamping portion, a second clamping portion and a clamping space, the first clamping portion and the second clamping portion disposed on the base and spaced apart from each other, the first clamping portion including a connecting portion and a clamping portion, the connecting portion connected with the base, the clamping portion connected with the connecting portion and moved relatively to the second clamping portion, the clamping portion and the second clamping portion formed the clamping space therebetween, and the resilient member resiliently abutted against between the connecting portion and the clamping portion.

2. The tool storage device of claim 1, wherein the connecting portion and the clamping portion are integrally connected with each other to form a U-shape.

3. The tool storage device of claim 2, wherein the tool clamping seat further includes a compression space formed between the connecting portion and the clamping portion, and the clamping portion is movable relative to the compression space.

4. The tool storage device of claim 3, wherein the resilient member is disposed within the compression space.

5. The tool storage device of claim 2, wherein the resilient member is substantially u-shaped, and a shape of the resilient member corresponds to a shape formed by the connecting portion and the clamping portion.

6. The tool storage device of claim 1, wherein the base defines a first direction and a second direction, the first direction is transverse to the second direction, the first clamping portion and the second clamping portion are arranged in the first direction, and the second clamping portion includes a plurality of clamping arms which are spaced apart from each other in the second direction.

7. The tool storage device of claim 1, wherein the base has a top surface, the clamping unit is disposed on the top surface, and the top surface has a recess which corresponds to the clamping portion.

8. The tool storage device of claim 1, wherein the clamping portion is wavy-shaped, the clamping portion includes a first curved segment and a second curved segment, the first curved segment is connected between the second curved segment and the connecting portion, the second curved segment is a free end and bends towards the connecting portion, and the first curved segment and the second curved segment bend in opposite directions.

9. The tool storage device of claim 1, wherein one of an inner wall of the first clamping portion and the resilient member has a locking protrusion, the other of the inner wall of the first clamping portion and the resilient member has a locking hole, and the locking protrusion is engaged within the locking hole.

10. The tool storage device of claim 4, wherein the resilient member is substantially u-shaped, and a shape of the resilient member corresponds to a shape formed by the connecting portion and the clamping portion; the resilient member is a metal flat leaf spring; the base and the clamping unit are integrally connected with each other; the base defines a first direction and a second direction, the first direction is transverse to the second direction, the first clamping portion and the second clamping portion are arranged in the first direction, and the second clamping portion includes a plurality of clamping arms which are spaced apart from each other in the second direction; each of the plurality of clamping arms obliquely extends towards the first clamping portion; a top portion of each of the plurality of clamping arms has an inclined surface that faces the first clamping portion; the base has a top surface, the clamping unit is disposed on the top surface, the top surface has a recess which corresponds to the clamping portion; the clamping portion is substantially wavy-shaped, the clamping portion includes a first curved segment and a second curved segment, the first curved segment is connected between the second curved segment and the connecting portion, the second curved segment is a free end and bends towards the connecting portion, and the first curved segment and the second curved segment bend in opposite directions; one of an inner wall of the first clamping portion and the resilient member has a locking protrusion, the other of the inner wall of the first clamping portion and the resilient member has a locking hole, and the locking protrusion is engaged within the locking hole; and the inner wall of the connecting portion has the locking protrusion, the resilient member includes a connecting end portion and a free end portion, the connecting end portion and the free end portion are integrally connected with each other, the connecting end portion has the locking hole, and the free end portion resiliently abuts against the clamping portion.
